(19) United States
(12) Patent Application Publication
(10) Pub. No.: US 2002/0013425 A1
(43) Pub. Date: Jan. 31, 2002

(54) Polymerizable compositions

(76) Inventors: Ronald E. Johnson, Tioga, PA (US); Khalil M. Moussa, Stevenson Ranch, CA (US); Paul J. Shustack, Elmira, NY (US); Kimberly S. Wayman, Gillet, PA (US)

Correspondence Address: Corning Incorporated, SP-TI-03, Corning, NY, 14831, US

(21) Appl. No.: 09/821,249

(22) Filed: Mar. 29, 2001

Related U.S. Application Data
(63) Continuation-in-part of application No. 09/368,675, filed on Aug. 5, 1999, now abandoned.

(51) Int. Cl. C08F 20/00

(52) U.S. Cl. 525/438

(57) ABSTRACT

The present application describes a method for initial polymerization or gelling a composition of epoxy resin at a temperature of 50° C. or less, over a period of 24 hours or less by the incorporation of a fluorinated carboxylic acid. The compositions used in the present invention can be gelled without the use of heat or light. The fluorinated carboxylic acid includes a carboxylic acid terminated fluoropolyether. The composition includes a cycloaliphatic epoxy resin. The invention further includes objects that comprise a polymerization product of a composition or materials prepared according to the method In addition, the present application describes the use of such materials in optical systems that include a first component, a second component, and the material disposed between the first and second optical components.

### CONTINUATION

This application claims priority to U.S. patent application Ser. No. 09/368,675, filed on Aug. 5, 1999, in the names of R. E. Johnson, K. M. Moussa, and K. S. Wayman.

### FIELD OF THE INVENTION

The subject invention relates to a method of gelling a polymerizable composition and, more particularly, to a polymerizable composition of an epoxy resin by adding a fluorinated carboxylic acid.

### BACKGROUND OF THE INVENTION

In recent times, the use of optical fiber communications has increased dramatically, and the promise of increased signal transmission speed and clarity makes it likely that the use of optical fibers for signal transmission will continue to increase in the future. Optical fiber technology can be used to transmit a variety of signals. For example, telecommunication, sensor, medical, and video transmissions can all take advantage of optical technology, particularly where virtually unlimited bandwidth and low attenuation are beneficial. Cable television systems are one example where optical fiber technology is providing efficient and economical alternatives to prior coaxial cable distribution schemes. Optical devices for transmitting, conducting, and receiving data are of great interest because of the potential for replacing many electrical circuits with optical circuits. The optical circuits are light in weight, secure, resistant to many types of radiation, and of small dimension. Moreover, more information can be transmitted through an optical line than through an electrical line of comparable size and weight.

In systems designed to optically transmit signals, light is guided through the optical system using optical fibers and waveguides. These optical fibers and waveguides typically include an inner glass core of transparent material surrounded by a glass cladding layer having a lower refractive index than the core. Due to this difference between the index of refraction of the core and the cladding, total internal reflection occurs, and the light entering one end of the fiber or waveguide is internally reflected along its length. According to the principle of total internal reflection, light entering the fiber or waveguide with the proper entry angle will be internally reflected at the interface between the core and the cladding and will proceed down the length of the fiber or waveguide with multiple internal reflections from the cladding layer surrounding the core, without any loss of intensity regardless of the number of multiple reflections.

If the fiber or waveguide is long, there must be such total internal reflection for the fiber or waveguide to be operable, as even a small percentage reduction of light intensity on each reflection would result in insufficient intensity of the beam emerging from the fiber or waveguide. Consequently, the optical fiber or waveguide must be carefully constructed so as to avoid any loss or leakage of light from the waveguide. Therefore, the glass used to construct an optical fiber or waveguide is highly perfect, having a low density of imperfections that could scatter light in a direction which would result in less than total internal reflection at the core/cladding interface.

Presently, optical fibers and waveguides having the necessary low density of imperfections are well known, and losses in signal strength occur primarily at the junction of two optical elements rather than over the even great distances of a single optical fiber. The problem of signal loss at the junctions of optical elements in an optical transmission system is intensified by the fact that optical systems are being increasingly used for local signal transmission. In contrast to long-haul transmissions, where signals are intended to be transmitted many miles without interruption, local transmission systems require many more optical fiber splices.

One method for making optical splices between optical fibers and/or waveguides involves the use of adhesives. Although a wide variety of adhesives having varied refractive indices, optical losses, adhesive strengths, flexibilities, and heat resisting properties are known, those having the optical properties needed for use as an optical adhesive for joining fibers and waveguides in an optical signal transmission system require the use of either heat or light to cure. In many circumstances, the use of heat and/or light is inconvenient, especially in cases where splices need to be made in the field under adverse conditions, frequently without access to specialized equipment. Moreover, the application of heat and light, in some instances, can causes damage to the components being joined.

Accordingly, a need exists for materials that bond optical components, such as fibers and waveguides together without heating, without the use of light, and without causing loss in signal strength or signal quality. The present invention is directed to meeting this need.

Low loss polymers are also of interest for molding light guides and other optical devices in which the polymers will be in the light path. These applications involve the use of high precision molds, which are usually constructed of nickel. Having an opaque mold surely is not conducive to curing by use of UV-light or other radiance. Additionally, any need to apply heat to cure or melt process the polymers tends to increase the difficulty of holding tight dimensional and alignment tolerances. As a consequence, a low viscosity liquid and polymer that can quickly hardened, but that does not require heat either for mold filling or removal would be of great benefit to the production of molded optical devices.

### SUMMARY OF THE INVENTION

The present invention relates to a method for gelling an epoxy resin composition by addition of a fluorinated carboxylic acid. More specifically, a carboxylic acid terminated fluoropolyether is incorporated into an epoxy formulation, preferably a cycloaliphatic epoxy formulation. The composition can be changed from a liquid to a gel at an ambient temperature of 50° C. or less, within 24 hours or less, without the need for curing by heat or light. Depending on the mass-volume, reaction or gelation times can be as short in duration as 1-2 hours. Preferably the time is as short as within about 15-20-30-45 minutes, more preferably within about 4 or 5-8 minutes, and most preferably under 1 minute (˜10-30-50 seconds). The present invention also relates to an object that includes a polymerization product of such a composition.

Further, the present invention relates to a material prepared by a method that comprises providing a composition that includes a carboxylic acid terminated fluoropolyether and a cycloaliphatic epoxy resin and polymerizing the composition to a gelled, elastic, or solid state at an ambient temperature of 50° C. or less, within 24 hours, without the need for curing by heat or light.

The present invention is also directed to an optical system that includes a first optical component, a second optical component; and a material disposed between the first optical component and the second optical component. The material is prepared by providing a composition that includes a carboxylic acid-terminated fluoropolyether and a cycloaliphatic epoxy resin and polymerizing the composition to a gelled, elastic, or solid state at an ambient temperature of 50° C. or less, within 24 hours, without the need for curing by heat or light.

Since the compositions of the present invention can be gelled or polymerized without the use of light or applied heat, accordingly, they are particularly useful as molding compositions or as adhesive compositions. They are especially useful for the fabrication of optical components or systems, in cases where it may be desirable to polymerize the composition without the use of heat or light.

### DETAILED DESCRIPTION OF THE INVENTION

Acids and anhydrides react notoriously sluggish with epoxides and require elevated temperatures to cure. Even gel temperatures are usually no cooler than about 80° C. and higher. See, for example, U.S. Pat. No. 5, 386,005 issued to Mascia et al. (carboxylic acids and anhydrides are cured with epoxides between 80° C. and 200° C.), and U.S. Pat. No. 5,420,202 issued to St. Clair et al.; the contents of both of these patents are incorporated herein by reference. Much work has been done one trying to achieve a relatively lower temperature cure for acid and/or anhydride cure formulations, but none so far has been successful. The present invention relates to a method for gelling a composition of epoxy resins by adding at least about 1% to about 5-50% by weight of a fluorinated carboxylic acid, which includes carboxylic acid terminated fluoropolyethers and epoxy resin containing formulations. A point of novelty being the ability to gel or cured all by itself at a temperature of 50° C. or less, more commonly at approximately room temperature, within a short time period.

The fluorinated carboxylic acid that can be used are those that have at least one fluorine atom on the carbon alpha to the carboxylic acid carbon. A generic representation of such a carboxylic acid is:

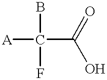

where A and B are hydrogen, fluorine, or a linear, branched, or cyclic hydrocarbon or halogenated hydrocarbon. The carboxylic acid can be di- or multifunctional so long as there is at least one fluorine atom on the carbon alpha to the carboxylic acid functional groups.

Carboxylic acid terminated fluorinated polyethers also can be used. Carboxylic acid terminated fluoropolyethers are meant to include polyethers that have at least one terminal carboxylic acid group and at least one fluorine atom. At least one fluorine atom is bonded to a carbon atom in an ether unit of the polyether, and, preferably, the carboxylic acid terminated fluoropolyether has at least 25% of the hydrogen atoms in its ether units replaced with fluorine atoms. For example, carboxylic acid terminated fluoropolyethers useful for the practice of the present invention include those which have more than 25 mole %, preferably more than 60 mole %, more preferably more than 90 mole %, of ether units selected from: —CF₂—CF₂—O—, —CF₂—O—, —CF(CF₃)—O—, and —CF₂—CF(CF₃)—O—. Such compounds can be made by processes as described in U.S. Pat. No. 5,446,205 to Marchionni et al., which is hereby incorporated by reference and, preferably, have a molecular weight of about 300 to 5000. Particularly preferred carboxylic acid terminated fluoropolyethers are carboxylic acid terminated perfluoropolyethers, illustrative examples of which are the Fomblin MF series of compounds manufactured by Ausimount Inc. (e.g., Fomblin MF 300) and the Fluorolink series of compounds manufactured by Ausimount Inc. (e.g., Fluorolink C).

It is preferable, but not required, that the epoxy be a cycloaliphatic epoxy resin.

Cycloaliphatic epoxy resins are those containing a cycloaliphatic group (e.g., cyclohexane, cyclopentane) in which hydrogen atoms on each of two adjacent carbons are replaced with a bridging oxygen atom (—O—). Preferred cycloaliphatic epoxy resins are those which have an epoxy equivalent weight of about 100-300. Commercial examples of representative suitable cycloaliphatic epoxies include 3,4-epoxycyclohexylmethyl-3,4-epoxycyclohexane carboxylate (e.g. “ERL-4221” from Union Carbide Corp.); bis(3,4-epoxycyclohexylmethyl)adipate (e.g. “ERL-4299” from Union Carbide Corporation);

3,4-epoxy-6-methylcyclohexylmethyl-3,4-epoxy-6-methylcyclohexane carboxylate (e.g. “ERL-4201” from Union Carbide Corp.); bis(3,4-epoxy-6-methylcyclohexylmethyl)adipate (e.g. “ERL-4289” from Union Carbide Corp.); bis(2,3-epoxycyclopentyl) ether (e.g. “ERL-0400” from Union Carbide Corp.); dipentene dioxide (e.g. “ERL-4269” from Union Carbide Corp.); 2-(3,4-epoxycyclohexyl-5,5-spiro-3-4-epoxy) cyclohexane-metadioxane (e.g. “ERL-4234” from Union Carbide Corp.). Other commercially available cycloaliphatic epoxies are available from Ciba-Geigy Corporation, such as CY 192, a cycloaliphatic diglycidyl ester epoxy resin having an epoxy equivalent weight of about 154. Other cycloaliphatic epoxy resins can be prepared according to standard methods, such as those set forth in U.S. Pat. Nos. 2,750,395, 2,884,408, 2,890,194, 3,027,357, and 3,318,822, which are hereby incorporated by reference. Combinations of these and other cycloaliphatic epoxy resins can also be employed in the compositions of the present invention. Cycloaliphatic polyepoxy resins (i.e., cycloaliphatic epoxy resins which contain two or more epoxide moieties, either on the same cycloaliphatic ring or on different cycloaliphatic rings), particularly, 3,4-epoxycyclohexylmethyl-3,4-epoxycyclohexane carboxylate, are preferred.

An example using ERL 4221 and Fluorolink C will illustrate the concept of the present invention. This reaction forms a gelled solid virtually instantaneously, depending on the mass. This combination could be added to epoxy adhesives for the sole purpose of achieving gelation at temperature of ˜25° C.±10° C. in an acid or anhydride cured epoxy, which is the new method of the present invention. Gelation is defined as conversion of the composition from a liquid or viscous state to a solid or tacky, elastic state. Room temperature or near room temperature gelation is significant to the processes for producing light guides, as well as to the practicality of using adhesives in many light path applications. Formulations that required 80° C. or higher for gelation would in many cases simply be impractical for use.

The composition of the present invention can also include other ingredients, depending on the intended method of polymerization and the desired properties of the polymerized product produced therefrom. For example, the compositions of the present invention can further include a non-cycloaliphatic epoxy monomer or oligomer. As used herein, “non-cycloaliphatic epoxy monomer or oligomer” is meant to include any epoxy resin which is not a cycloaliphatic epoxy resin, as described above. Examples of suitable non-cycloaliphatic epoxy monomers and oligomers include non-cycloaliphatic polyepoxides, such as aliphatic and aromatic polyepoxies, such as those prepared by the reaction of an aliphatic polyol or polyhydric phenol and an epihalohydrin. Other useful epoxies include epoxidized oils and acrylic polymers derived from ethylenically unsaturated epoxy-functional monomers such as glycidyl acrylate or glycidyl methacrylate in combination with other copolymerizable monomers such as the (meth)acrylic and other unsaturated monomers. Representative useful (meth)acrylic monomers include methyl acrylate, ethyl acrylate, propyl acrylate, isopropyl acrylate, butyl acrylate, isobutyl acrylate, ethyl hexyl acrylate, amyl acrylate, 3,5,5-trimethylhexyl acrylate, methylmethacrylate, lauryl methacrylate, butyl methacrylate, acrylonitrile, methacrylonitrile, acrylamide, and methacrylamide. Other copolymerizable monomers include vinyl acetate, vinyl propionate, vinyl butyrate, vinyl isobutyrate, vinyl benzoate, vinyl m-chlorobenzoate, vinyl p-methoxy benzoate, vinyl chloride, styrene, α-methyl styrene, diethyl fumarate, dimethyl maleate, etc. The epoxy-functional monomers, when used, should normally not contain acid functionality or other functionality reactive with epoxide groups. Particular examples of epoxy resins suitable for use in the compositions of the present invention include epoxy derivative resins, such as Polyset PC-1000 (available from Polyset Comapny, Inc., Mechanicsville, N.Y.), EPALLOY™ 5000 (available from CVC, Cherry Hill, N.J.), bisphenol-A epoxy resins, and novalac epoxy resins.

Typically, use of non-cycloaliphatic epoxy resins decreases the rate at which the composition of the present invention cures when compared to compositions containing cycloaliphatic epoxy resins, carboxylic acid terminated fluoropolyethers, and no non-cycloaliphatic epoxy resins.

In the case where the polymerization product of the composition is to be used in optical signal transmission, it may be desirable to add materials that are known to reduce optical loss, for example, colloidal silica to the compositions of the present invention.

Another component that can optionally be included in the composition of the present invention is a catalyst for the reaction of epoxy and acid groups. Tertiary amines, secondary amines, quaternary ammonium salts, and nucleophilic catalysts, such as lithium iodide, phosphonium salts, and phosphines (e.g., triphenyl phosphine) are especially useful as catalysts for epoxy/acid reactions. The catalyst for the epoxy/acid reaction, if used, will typically be present at a level of at least 0.01% by weight of the total acid-functional polymer and epoxy-functional compound and will preferably be present at about 0.1 to about 3.0%.

The compositions of the present invention can also include a polymerization initiator, such as a photoinitiator or a thermal initiator. For example, in circumstances where the composition of the present invention is to be light-cured, cationic photoinitiators, such as Sartomer CD1010, can be advantageously employed. The compositions of the present invention, however, are intended to be polymerized at room temperature without the use of light or heat.

The composition of the present invention can optionally contain a curing agent, such as a cross-linking agent, for example, anhydrides, particularly, dianhydrides of diacids. In certain applications, particularly in cases where the compositions are being used to form materials to be used in optical signal transmission, it is advantageous to use anhydrides containing chlorine atoms, such as chlorendic anhydride, because, it is believed, the halogenation further reduces optical losses. Moreover, the use of chlorine-containing anhydrides is advantageous, because the chlorine content of the anhydride facilitates counterbalancing the fluorine content of the carboxylic acid terminated fluoropolyethers when attempting to adjust the composition's index of refraction. Anhydride-functional compounds that are useful in the practice of this invention include any aliphatic or aromatic compound having at least two cyclic carboxylic acid anhydride groups in the molecule. For example, compositions in which chlorendic anhydride and hexahydrophthalic anhydride are present in weight ratios of from about 30:70 to about 50:50 are illustrative of an embodiment of the present invention, as are compositions in which chlorendic anhydride and hexahydrophthalic anhydride are present in weight ratios of about 40:60 and those in which chlorendic anhydride and hexahydrophthalic anhydride are present as a eutectic mixture. Polymeric anhydrides, such as acrylic polymers having anhydride functionality and having number average molecular weights between 500 and 7,000 are also useful. These are conveniently prepared, as is well known in the art, by the polymerization under free radical addition polymerization conditions of at least one unsaturated monomer having anhydride functionality, such as maleic anhydride, citraconic anhydride, itaconic anhydride, propenyl succinic anhydride, etc. optionally with other ethylenically unsaturated monomers such as the esters of unsaturated acids, vinyl compounds, styrene-based materials, allyl compounds and other copolymerizable monomers. Other polyanhydrides can also be optionally utilized in the practice of this invention. Ester anhydrides can be prepared, as is known in the art, by the reaction of e.g. trimellitic anhydride with polyols. Still other representative, suitable anhydrides include poly-functional cyclic dianhydrides such as cyclopentane tetracarboxylic acid dianhydride, diphenyl-ether tetra-carboxylic acid dianhydride, 1,2,3,4,-butane tetracarboxylic acid dianhydride, and the benzophenone tetracarboxylic dialihydrides, such as 3,3′,4,4′-benzophenone tetracarboxylic dianhydride, and 2-bromo-3,3′,4,4′-benzophenone tetracarboxylic acid dianhydride. Trianhydrides such as the benzene and cyclohexene hexacarboxylic acid trianhydrides are also useful. When the composition of the present invention includes an anhydride-functional compound along with the cycloaliphatic epoxy resins and carboxylic acid terminated fluoropolyethers compound, the ratios of anhydride to acid to epoxy groups can be widely varied to give any desired level of crosslinking. Typically, the anhydride should be present in an amount to provide at least about 0.1 anhydride groups for each epoxy group in the reactive coating.

The use of cross-linkers, such as the anhydrides discussed above are particularly advantageous in cases where it is desirable that the products of polymerization of the compositions of the present invention have higher Tg's. When the composition of the present invention incorporates an anhydride-functional compound along with the acid-functional polymer and the epoxy-functional compound, the ratios of anhydride to acid to epoxy groups can be widely varied to give any desired level of crosslinking within the practice of this invention. Typically, the polyanhydride should be present in an amount to provide at least about 0.1 anhydride groups for each epoxy group in the reactive coating. Typically, when the compositions of the present invention include anhydrides, they usually require a post cure step, for example, using heat or light or both (as discussed further below), to achieve optimal Tg's.

Alternatively, higher Tg's can be achieved by including in the composition materials known to promote curing of resins containing cycloalkene oxide (e.g., cyclohexene oxide and cyclopentene oxide) groups. Especially suitable for achieving higher Tg's are metal salts, such as a metal carboxylic acid salts, metal alcoholates, and metal phenolates), particularly metal linear alkanoic acid salts (e.g., zinc octoate and stannous octoate). Typically, these materials are used in an amount of 0.1 to 1.0 part by weight per 100 parts of composition.

The composition of the present invention can be made from its components by combining them using a suitable mixer to form a mixture, preferably a homogenized mixture. For example, the mixing can be carried out with an in-line mixer, especially in cases where the composition is to be used in a process such as reactive injection molding or reactive transfer molding. Optionally, one or more of the components of the composition can be dissolved or suspended in a suitable solvent prior to being mixed with the other components of the mixture.

The compositions of the present invention can be used to produce a variety of articles of manufacture including molded articles, cast articles, sheet materials, sealants, adhesives, encapsulants, coatings, paints (i.e., coatings containing a pigment), and the like. Applications that will particularly benefit from the compositions of the invention include those that relate to optical signal transmission.

Depending on the ultimate use to which the composition is put, the composition, prior to polymerization can be formed into a mold, cast into sheets, or disposed on or between other materials. For example, in the case where the composition of the present invention is to be formed into a waveguide it can be cast into an appropriate mold by conventional methods, such as by injection molding. Alternatively, in the case where the composition is to be used as an adhesive between two materials, it is positioned between the materials prior to polymerization.

Once the composition of the present invention is thus provided, it is polymerized to produce a polymerization product. Polymerization can be permitted to take place at room temperature (approximately 20° C. to about 25° C.) without the need or use of additional outside heat and without the need or use of light, although not necessarily under “dark conditions”. For purposes of the present invention, “polymerization” is meant to include partial polymerization to a gel state rather than a hardened state. For the purposes of the present invention, “without the use of heat” is meant to include situations in which the composition warms to greater than room temperature by the heat produced by exothermic polymerization. For the purposes of the present invention, “without the use of light” is meant to include situations in which the composition is exposed to light, such as ambient lighting conditions, so long as the rate of polymerization of the composition when so exposed to light is not significantly greater (i.e., less than 10% greater) than the rate of the composition's polymerization in the complete absence of light. Further, “polymerization . . . without the use of heat” and “polymerization . . . without the use of light” does not refer to post-curing steps. Post curing steps, as used herein, refer to those steps carried out after the composition is sufficiently gelled or polymerized to be handled or, where appropriate, demolded. As will be explained in greater detail below, polymerization can be effected “without the use of heat” and “without the use of light” and subsequently followed with a post cure step, which involves the use of heat or light or both.

Typically, polymerization without the use of heat and without the use of light is carried out over a period of from about a few hours to about a few days. Usually, polymerization can be effected in about one day.

The method of the present invention polymerizes an epoxy resin composition without the use of heat and without the use of light and then post-cured using heat or light or both. Post curing is particularly advantageous when materials having higher Tg's and improved long term stability are desired. For example, post curing can be carried out by heating the polymerized composition at from about 100° C. to about 250° C. for from about 1 minute to about 5 hours, preferably for from about 15 minutes to about 2 hours. Thermal post curing can also be carried out on compositions which have been polymerized using light.

As indicated above, the compositions of the present invention, when polymerized, are particularly useful in optical systems to join together two or more optical components thereof. For example, in one embodiment of this aspect of the present invention, the optical system includes a first component and a second optical component and, disposed therebetween, a material prepared by polymerizing a composition according to the present invention, as described above. Illustrative optical components that can be joined in this fashion are two optical fibers, two waveguides, and an optical fiber and a waveguide. As one skilled in the art would appreciate, optimization of a process using adhesive to join optical components, such as two optical fibers, requires that the components be substantially aligned along their axes, so that signal passing through one fiber, for example, completely enters the second fiber. Methods for aligning optical components, particularly optical fibers, are well known in the art. For example, a device similar to the one used in the Norland self-aligning UV curable splice system (see, e.g., U.S. Pat. No. 4,960,316 to Berkey, which is hereby incorporated by reference) and the Lightlinker fiber optic splice system (see, e.g., U.S. Pat. No. 4,889,405 to Walker et al. and U.S. Pat. No. 4,506,946 to Hodge, which are hereby incorporated by reference). These splices include a central glass alignment guide composed of four tiny glass rods which have been fused together to provide a hollow core containing four V-grooves at the fused tangential points. The ends of the guide are bent somewhat along the longitudinal axis. This forms a fiber deflecting elbow on either side of a straight central portion of the guide. When fibers are inserted into the guide, the upward or downward slope of the ends forces the fibers to orient themselves in the uppermost or lowermost V-grooves of the guide, respectively. When the fibers meet at the center portion, they are both tangent to the guide surfaces so that the ends thereof abut each other. The splice is used by first filling the central opening with a composition of the present invention. After the fibers are prepared by stripping any exterior resin coating and squaring of the ends, they are inserted into the splice so as to be aligned when they contact each other. The composition of the present invention is then allowed to polymerize or is polymerized by exposing the composition to light (e.g., UV light) as discussed above, thus encapsulating the fiber and providing handling strength. Other methods for aligning optical fibers for splicing are described in, for example U.S. Pat. No. 5,042,902 to Huebscher et al. and U.S. Pat. No. 4,690,316 to Berkey, which are hereby incorporated by reference.

Optical waveguides or other optical fibers that are suitable for use in the optical systems of the present invention can be made by conventional methods, such as those set forth in U.S. Pat. Nos. 3,659,915 and 3,884,550 to Maurer et al.; U.S. Pat. Nos. 3,711,262, 3,737,292, and 3,775,075 to Keck et al.; U.S. Pat. No. 3,737,293 to Maurer;

U.S. Pat. No. 3,806,570 to Flamenbaum et al.; U.S. Pat. No. 3,859,073 to Schultz, each of which is hereby incorporated by reference.

The present invention is further illustrated by the following non-limiting examples.

### EXAMPLES

### Example 1

### Room Temperature (RT) Gelled and Anhydride Cure Compositions

Three compositions, denoted Sample 2, Sample 5, and Sample 6, were prepared using ERL-4221 (3,4-epoxycyclohexylmethyl-3,4-epoxycyclohexane carboxylate from Union Carbide, Inc.), Fluorolink C (a carboxylic acid terminated perfluoropolyethers from Ausimount Inc.), a 40:60 (w/w) mixture of chlorendic anhydride (“CA”) and hexahydrophthalic anhydride (“HHPA”), and zinc octoate. The compositions were allowed to polymerize at room temperature for 24 hours and then post-cured at 150° C. for 15 minutes, at 150° C. for 15 minutes followed by 200° C. for 15 minutes, at 150° C. for 1 hour, and/or at 200° C. for 15 minutes. The weights of the various components in each of Samples 2, 5, and 6 and the Tg (measured by dynamic mechanical analysis (“DMA”)) and modulus (at 25° C.) are reported in Table 1, below. Samples 5 and 6 gelled immediately, within about 3 or 4-10 seconds of initial reaction.

Two further examples of epoxys which react with Fluorolink C are diglycidyl ether of bisphenol-A (D.E.R. 332), and epoxy novolac resin (D.E.N. 431) both available from Dow Chemical. For a 1:1 by weight sample of Diglycidyl Ether of Bisphenol A and Fluorolink C, it was observed that the reaction produced a cured, solid at RT in 60 minutes, although with a slight haze. For a 2:1 by weight sample of Epoxy Novolac Resin, the reaction formed a body that gelled quickly, but cloudy.

TABLE 1

| | Sample 2 | Sample 5 | Sample 6 |
|---|---|---|---|
| ERL-4221 (wt %) | 71.4 | 60 | 54.5 |
| Fluorolink C | 28.6 | 27.3 | 30.5 |
| CA/HHPA (40:60) | 0 | 12.7 | 14.5 |
| (wt %) | | | |
| zinc octoate (wt %) | 0 | 0 | 0.5 |
| RT/24 hours | | | |
| DMA Tg (° C.) | −48.6 & −14 | | |
| modulus (at 25° C.) | 2.7 × 10⁶ pa | | |
| 150° C./15 minutes | | | |
| DMA Tg (° C.) | | 25 | 54 |
| modulus (at 25° C.) | | 3.7 × 10⁷ pa | 6.4 × 10⁸ pa |

150° C./15 minutes + 200 C/15 minutes

| | | | |
|---|---|---|---|
| DMA Tg (° C.) | | 78.9 | 59 |
| modulus (at 25° C.) | | 1.6 × 10⁷ pa | 1 × 10⁹ pa |
| 150° C./1 hour | | | |
| DMA Tg (° C.) | −16 | 53.6 | 84 |
| modulus (at 25° C.) | 3 × 10⁶ | 3.47 × 10⁸ pa | 1.61 × 10⁹ pa |
| 200° C./15 minutes | | | |
| DMA Tg (° C.) | | 38.1 | 65 |
| modulus (at 25° C.) | | ˜2 × 10⁸ pa | 9.4 × 10⁸ pa |

### Example 2

### UV Curable Compositions

Three compositions, denoted Sample 1, Sample 3, and Sample 7, were prepared using ERL-4221, Fluorolink C, CD1010 (a cationic photoinitiator from Sartomer), and PC-1000 (a non-cycloaliphatic epoxy derivative resin available from Polyset Comapny, Inc. (Mechanicsville, N.Y.) under the tradename Polyset PC-1000). The compositions were exposed to two passes of ultraviolet light at an intensity of 4.0 J/cm² and then post-cured at 150° C. for 1 hour. The weights of the various components in each of Samples 1, 3, and 7 and the Tg (measured by DMA) and modulus (at 25° C.) are reported in Table 2, below.

TABLE 2

| | Sample 1 | Sample 3 | Sample 7 |
|---|---|---|---|
| ERL-4221 (wt %) | 69.7 | 34.6 | 84.6 |
| Fluorolink C | 29.9 | 30.3 | 14.9 |
| CD1010 (wt %) | 0.5 | 0.5 | 0.5 |
| PC-1000 (wt %) | 0 | 34.6 | 0 |
| UV-2 passes at 4.0 J/cm² | | | |
| DMA Tg (° C.) | 101 & 168 | 34 | 168 |
| modulus (at 25° C.) | 1.2 × 10⁹ pa | ˜2 × 10⁸ pa | 2.4 × 10⁹ pa |
| UV + 150° C./1 hour | | | |
| DMA Tg (° C.) | 197.8 | 98.6 | 223.2 |
| modulus (at 25° C.) | 1.6 × 10⁹ pa | 1 × 10⁹ pa | 2.4 × 10⁹ pa |

### Example 3

### Fluorinated Carboxylic Acids

When about 1 g. of trifluoroacetic acid is added to about 1 g. of epoxy cyclohexylmethyl-3,4-epoxycyclohexane carboxylate an immediate reaction occurs to cause polymer formation at room temperature. In comparison, when 1 g. of acetic acid is added to 1 g. of epoxy cyclohexylmethyl-3,4-epoxycyclohexane carboxylate, no reaction occurs and no polymer forms. The presence of fluorine adjacent to the carboxyl group increases acidity of the acetic molecule. Under the catalytic influence of a relatively strong acid, the epoxy is believed to homo-polymerize at an interface.

Although the invention has been described in detail and examples provided for the purpose of illustration, it is understood that changes and variations may be made to an embodiment of the invention by those skilled in the art without departing from the spirit and scope of the invention which is defined by the following claims.

We claim:

1. A method for gelling a composition of epoxy resin, the method comprises: incorporating at least about 1% by weight of a fluorinated carboxylic acid to said composition, reacting said epoxy resin at an ambient temperature of 50° C. or less, and gelling within 24 hours or less, without the need for curing by the use of heat or light.

2. The method according to claim 1, wherein about 1% to about 50% by weight of a carboxylic acid is added to said composition.

3. The method according to claim 1, wherein said reacting step has a gelling duration of about 1-2 hours.

4. The method according to claim 1, wherein said reacting step has a gelling duration of within about 15-45 minutes.

5. The method according to claim 1, wherein said reacting step has a gelling time of within about 4-8 minutes.

6. The method according to claim 1, wherein said reacting step has a gelling time of under 1 minute

7. The method according to claim 1, wherein said reacting step has a gelling time of under ˜30 seconds.

8. The method according to claim 1, wherein said reacting step occurs at about (25° C.±10° C.).

9. The method according to claim 1, wherein said reacting step occurs at approximately room temperature.

10. The method according to claim 1, wherein of said fluorinated carboxylic acid is a carboxylic acid terminated fluoropolyether, and said epoxy resin is a cycloaliphatic epoxy resin.

11. The method according to claim 10, wherein said cycloaliphatic epoxy resin is a cycloaliphatic polyepoxy resin.

12. The method according to claim 10, wherein said cycloaliphatic epoxy resin is selected from the group consisting of a 3,4-epoxycyclohexylmethyl-3,4-epoxy cyclohexane carboxylate; a bis(3,4-epoxycyclohexylmethyl)adipate; a 3,4-epoxy-6-methylcyclohexylmethyl a 3,4-epoxy-6-methylcyclohexane carboxylate; a bis(3,4-epoxy-6-methylcyclohexylmethyl)adipate; a bis(2,3-epoxycyclopentyl) ether; a dipentene dioxide; a 2-(3,4-epoxycyclohexyl-5,5-spiro-3-4-epoxy) cyclohexane-metadioxane; and a cycloaliphatic diglycidyl ester epoxy resin.

13. The method according to claim 10, wherein said cycloaliphatic epoxy resin is a 3,4-epoxycyclohexylmethyl-3,4-epoxy cyclohexane carboxylate.

14. The method according to claim 10, wherein said carboxylic acid terminated fluoropolyether is a carboxylic acid terminated perfluoropolyether.

15. The method according to claim 10, wherein said carboxylic acid terminated fluoropolyether is a carboxylic acid terminated perfluoropolyether having a molecular weight of from about 300 to about 5000.

16. The method according to claim 10, further comprising incorporating a non-cycloaliphatic epoxy monomer or oligomer.

17. The method according to claim 10, further comprising including a photoinitiator.

18. The method according to claim 10, further comprising incorporating a curing agent.

19. The method according to claim 10, further comprising incorporating an anhydride.

20. The method according to claim 19, wherein said anhydride is a chlorine-containing anhydride.

21. The method according to claim 19, wherein said anhydride is chlorendic anhydride.

22. The method according to claim 19, further comprising adding a second anhydride.

23. The method according to claim 22, wherein said first anhydride is chlorendic anhydride and wherein said second anhydride is hexahydrophthalic anhydride.

24. The method according to claim 24, wherein the chlorendic anhydride and hexahydrophthalic anhydride are present as a eutectic mixture.

25. The method according to claim 24, wherein the chlorendic anhydride and hexahydrophthalic anhydride are present in a weight ratio of 40:60.

26. The method according to claim 1, wherein said composition is substantially free of photoinitiators.

27. The method according to claim 1, wherein said composition is substantially free of thermal initiators.

28. The method according to claim 1, wherein said composition is substantially free of photoinitiators and thermal initiators.

29. An object comprising a polymerization product of a composition gelled according to a method comprising the steps of: incorporating at least about 1% by weight of a fluorinated carboxylic acid to said composition, reacting said epoxy resin at an ambient temperature of 50° C. or less, and gelling within 24 hours or less, without the need for curing by the use of heat or light.

30. A material prepared by a method comprising: incorporating at least about 1% by weight of a fluorinated carboxylic acid to a composition of epoxy resin, reacting said composition of epoxy resin at an ambient temperature of 50° C. or less, and gelling within 24 hours or less.

31. The material according to claim 30, wherein said gelling step is carried out without the use of light.

32. The material according to claim 30, wherein said gelling step is carried out without the use of heat.

33. A material according to claim 30, wherein said gelling step is carried out without the use of heat and without the use of light.

34. An optical system comprising: a first component; a second component; and a material according to claim 23 disposed between said first component and said second component.

35. The method according to claim 1, wherein said carboxylic acid has a general formula of: 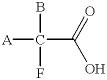
where A and B are selected from a group consisting of hydrogen, fluorine, or a linear, branched, or cyclic hydrocarbon or halogenated hydrocarbon, and where said carboxylic acid can be di- or multifunctional so long as at least one fluorine atom is on the carbon alpha to the carboxylic acid functional groups.
